(19) United States
(12) Patent Application Publication
(10) Pub. No.: US 2023/0245052 A1
(43) Pub. Date: Aug. 3, 2023

(54) METHOD OF REUSING A REUSABLE TRANSPORT PACKAGING AND A SERVICE POINT AND SYSTEM THEREFOR

(71) Applicant: PERO SOLUTIONS APS, Sønderborg (DK)

(72) Inventor: Allan Kaczmarek, Sønderborg (DK)

(21) Appl. No.: 17/625,739

(22) PCT Filed: Jul. 7, 2020
(86) PCT No.: PCT/DK2020/050203

§ 371 Date: Jan. 8, 2022

(30) Foreign Application Priority Data
Jul. 10, 2019 (DK) PA 2019 70454

(51) Int. Cl. G06Q 10/087

(52) U.S. Cl. CPC G06Q 10/087

(57) ABSTRACT

The method uses a status server in communication with a parcel allocation system. The parcel allocation system has one or more service points. At the service points (20) a reusable transport packaging (600) is provided and is reused by changing its content and the status server (730) is updated with a status (620) associated with the transport packaging ID (602), which status (620) is a function of a system event (54) performed in the parcel allocation system (400). The packaging (600) can be left at the service point (20). The service point (20) has storage means (201) for a packaging (602) and communication means (202) for receiving and transmitting data of system events (54). The system (700) has a status server (730) and packaging (600) for holding a piece (40). The system can receive (124) dataset (59) of a system event (54) from a parcel allocation system (400) and transmit (122) a status (620) of the packaging (600) to a parcel allocation system (400). The packaging (600) has a transport packaging ID (602) associated with a status (620) of the packaging (600), which status is dependent on the received dataset (59) of the system event (54) from the parcel allocation system (400). The parcel allocation system is a system wherein electronic tokens are transmitted between the server and a service point. The parcel allocation system (400) has one or more service points (20) and an external server (30).

### FIELD OF THE INVENTION

The present disclosure relates to reusable transport packing, use hereof and method therefor and a packaging reusing system.

Disclosed is a method of reusing a reusable transport packaging using a status server in communication with in a parcel allocation system. The parcel allocation system may comprise one or more service points.

Disclosed is the use of a reusable transport packaging in a parcel allocation system. The parcel allocation system may comprise a server and one or more service points.

Disclosed is a packaging reusing system for reusing reusable transport packaging. The packaging reusing system may comprise a status server and reusable transport packaging adapted for holding a piece. The packaging reusing system may comprise means adapted for receiving data of a system event from a parcel allocation system and for transmitting a status of the reusable transport packaging to a parcel allocation system. The parcel allocation system may be a system wherein electronic tokens are transmitted between the server and a service point.

Disclosed is a transport packaging adapted for holding a piece being a reusable transport packaging.

The reusable transport packaging may comprise a chip with a transport packaging ID. The chip may be fixed to the reusable transport packaging. The transport packaging ID may be associated with a status of the reusable transport packaging, which status is dependent on a system event performed in the parcel allocation system.

### BACKGROUND OF THE INVENTION

In recent years, circular economy has been widely discussed and small steps are being taken to introduce circular economy into the life cycle of various products. Circular economy breaks with the prior approach to products being produced, used and disposed of and even to be recycled to look in the direction of designing products to be reused more intensively before being disposed of or recycled. This may reduce the use of resources in terms of less handling and processing in regard to the recycling cycles. This may furthermore prolong the lifetime of the material used in an initial product, as with our knowledge today many materials may have a limited number of recycling cycles or requires blending in virgin material in the pre-used material to be recycled.

One challenge of circular economy is how to route the product to be reused between a former user and a post user and how to connect the users of a product. Reuse may take place through many different routes and involves many actors. This complexity makes monitoring and increasing reuse particularly challenging and thus, reuse are often concentrated to local government collections or to ad-hoc local pass along of used products.

The step to increase the levels of reuse and to manage subsequent recycling or waste streams more effectively may call for new business approaches to make a significant contribution to implement the circular economy.

One business model which involves similar aspects is distribution and allocation of parcels, which typically involves multiple partners in the process from the time the consignor or consignee/receiver of the parcel orders a parcel delivery until the consignee receives the parcel. The involved partners may include multiple couriers, postal or logistics providers. In addition; the process may include multiple acts of handling the parcel. This may include acts of transporting, receiving, delivering or handing out the parcel, and storing the parcel.

In general, the distribution and allocation of parcels is continuously being optimised to include lower storage time and less manual handling.

Especially the distribution and allocation of parcels on an ad hoc basis, where the consignor and consignee do not have regular or large shipments, e.g. weekly or daily delivery of large shipments from company to company, is generally changing to include an assigned pick-up place or service point, where the consignee can collect the parcel within a given time interval.

The number of serviced postal offices for handing out parcels is decreasing and the serviced postal offices are being replaced by self-service parcel lockers. The self-service parcel lockers may have a lower storage capacity than the postal offices but may be distributed more broadly to generate more delivery and/or pick-up places.

Today, a wide variety of parcel allocation systems are used which communicate directly or indirectly with a server using communication standards for data transmission including mobile telecommunication e.g. GSM, UTMS and/or communication standards of a wireless personal area network (WLAN).

### OBJECT OF THE INVENTION

It is an objective to present a solution for reusing packaging products. The objective includes both a method and a system therefore but also a packaging product and a use of a packaging product.

### DESCRIPTION OF THE INVENTION

An object of the disclosure may be achieved by a method of reusing a reusable transport packaging with a transport packaging ID, using a status server in communication within a parcel allocation system. The parcel allocation system may comprise one or more service points. The method may comprise acts performed at the service point. One act may be to change the content of the reusable transport packaging. A further act may be, in the status server, to update a status associated with the transport packaging ID, which status is a function of a system event performed in the parcel allocation system.

Changing the content of the reusable transport packaging may include removing and/or inserting a piece from/into the reusable transport packaging.

The method may comprise the use of multiple parcel allocation systems in communication with the status server.

One effect of the method is that a transport packaging suitable for being reused, may be recircled in a distribution system. The reusable transport packaging may be used for additional successive shipments of pieces. The shipments may be from a consignor to a consignee. For successive shipments both the successive consignor and the successive consignee may not be related/associated with the previous consignee or consignor in any way.

The reusable transport packaging may be recircled by being distributed within a distribution system comprising one or more parcel allocation systems. The reusable transport packaging may be recircled and hence, used for numerous shipments before eventually, if damaged or worn out, being rejected from recirculation in the parcel allocation system to be repaired or to be recycled. The reusable transport packaging may be recycled into either new reusable transport packaging, other products or disposed of in a sustainable way.

One effect may be that consignor of a piece may order a shipment using a reusable transport packaging, and thereby avoid obtaining a suitable transport packaging for the piece to be shipped at another location. Hence, instead of purchasing and thus owning the transport packaging, the consignor of a piece may simply rent the reusable transport packaging during shipment.

The consignor or consignee may for example be an e-retailer with the need for shipping or receiving multiple parcels over a period. In this case, the e-retailer may need to have multiple reusable transport packaging available at his private site. The e-retailer may act as a service point or a parcel allocation system comprising a service point. The e-retailer may thus be in communication with the status server.

The availability of a reusable transport packaging at a given service point and the recirculation of the reusable transport packaging may be managed by one or more couriers distributing parcels within or between the one or more parcel allocation systems, thereby achieving a distributed architecture for the reusable transport packaging by combining this with an associated distributed architecture for parcel allocation.

Any available reusable transport packaging may be recirculated within or between parcel allocation systems and reused by a consignor at the same service point, at a different service point, at a (e-)retailer location or comparable locations.

In one embodiment, the method may comprise the further act of leaving the reusable transport packaging at the service point of the parcel allocation system.

One effect may be that the receiver of a piece may leave the packaging. The receiver may simply collect the piece and leave the transport packaging at the service point. The transport packaging may then be reused by a subsequent user e.g. a consignor who orders a new delivery of a piece to be collected at the present service point (collect point) and to be delivered at a different service point using a reusable transport packaging. The consignor may simply arrive at the present collect point and arrange the piece to be shipped in the reusable transport packaging.

Thus, an additional advantage may be that the consignor himself does not have to purchase suitable transport packaging but simply make use of existing reusable transport packaging.

Availability of reusable transport packaging and the distribution hereof within the system can benefit from the parcel allocation system competence herein to recircle the reusable transport packaging to a service point, a retailer location or comparable locations where the demand by the next user arises.

The piece may comprise a piece specific packaging. This piece specific packaging may be identical to the packaging that you would obtain when purchasing a product in a store e.g. when purchasing a piece of clothes, it may be wrapped in a sheet of paper and/or a plastic bag, when purchasing a mobile phone, it may be contained in the producer's packaging. This piece specific packaging is different from the transport packaging. The term piece may therefor in this disclosure describe both the piece itself and a piece specific packaging.

In one embodiment, the method may comprise further acts performed at the service point of receiving a dataset of a system event to be performed and generating a service point signal for the system event (54). Furthermore, a dataset may be generated for a performed system event associated with the transport packaging ID.

One effect of this embodiment may be to implement the method in existing parcel allocation systems and/or existing service points, while ensuring that the status of the reusable transport packaging can be updated based on the system event performed.

The existing service points may include manned service points such as postal offices, automated service points such as parcel lockers or (e-)retailers being associated with a parcel allocation system as a service point or being a parcel allocation system in itself.

In one embodiment of the method, the parcel allocation system may comprise an external server in communication with the one or more service points.

The method may comprise an act performed at the external server of associating the transport packaging ID directly or indirectly with a service point.

The method may comprise another act performed at the external server of generating and transmitting a dataset of a system event to be performed at the service point.

One effect of this embodiment may be to implement the method in existing parcel allocation systems wherein the external server may communicate with multiple service points. The external server may hold an updated record of the status of the service points and/or existing service points, while ensuring that the status of the reusable transport packaging can be updated based on the system event performed.

In one aspect, the external server and the status server may be an integrated unit or separate units set up to communicate using a hardwired connection or a wireless connection using any suitable communication standard including WLAN network communication standards.

In one further embodiment of the method implemented with the parcel allocation system comprising an external server in communication with the one or more service points, may comprise the further acts for each reusable transport packaging of generating a sequence of successive electronic tokens associated directly or indirectly with the transport packaging ID and a service point and transmitting the electronic tokens between the external server and the service point.

The sequence of successive electronic tokens may comprise a user electronic token, a synchronisation electronic token and an acknowledgement electronic token.

The user electronic token may comprise a dataset of the system event to be performed. The dataset may be generated at the external server and transmitted to the service point.

The synchronisation electronic token may be generated at the service point in response to the performed system event and transmitted to the external server.

The acknowledgement electronic token may be generated at the external server in response to the received synchronisation electronic token and transmitted to the service point.

For the embodiments of this disclosure which include the use and/or generation of electronic tokens, the following may be general aspects:
The electronic tokens may comprise a piece ID associated with a piece.
Each service point may have a service point ID.
Electronic token may be referred to as e-token. An electronic token may be data content which may be comprised in a single file. In one aspect, the user e-tokens may be tagged with a service point ID.
The piece ID and the transport packaging ID may be global unique identifiers (GUID).
The user e-token may refer to the dataset to be communicated between the server and a service point. This data may concern a specific collection or delivery of a parcel from/to that service point and hence concern the user of the system, who is the sender or receiver of the parcel from that service point. The user e-token may be of a character which requires interaction with that given user of the system, either as a carrier of the e-token or to authorise the use of the e-token to gain access to collect or deliver the parcel at the service point.

The parcel allocation system may ensure a distributed architecture for parcel allocation, where the parcels are allocated to one or more service points, and each service point may return information to the server via a synchronisation e-token, when a user e-token has been ‘used’ at a service point. The synchronisation e-token may comprise sufficient information to provide for the service point status, such that the server may continuously hold information of the current status of the one or more service points.

The user e-token may hold information of a system event, such as a delivery or pick-up of a parcel to be performed. The synchronisation e-token may hold information of or associated with the performed system event. Other system events may be relevant in such a system such as service, maintenance or comparable events.

Hence, the use of a synchronisation e-token may ensure that sufficient information is received at the server concerning each service point to continuously hold an updated status of the service point capacity. The acknowledgement e-token may be a handshake sent from the server to the service point.

In one case, a consignee of a piece sent in a reusable transport packaging may at the service point (in this case: collect point) gain access to the parcel via a user e-token, open the reusable transport packaging and remove the piece and leave the packaging to be reused. A synchronisation token may be transmitted to the server and an acknowledgement transmitted to the service point. Due to associating the packaging ID with a system event in the parcel allocation system, the status of the reusable transport packaging may change from occupied to available in this case, where the system event is a collect event.

In another case, being an opposite scenario to the case described above, a consignor may make a delivery of a piece using a service point and a reusable transport packaging. The consignor may at the service point (in this case: delivery point) access an available reusable transport packaging at the service point via a user e-token, arrange the piece in the packaging and leave the package to be collected by a courier. A synchronisation token may be transmitted to the server and an acknowledgement transmitted to the service point. Due to associating the packaging ID with a system event in the parcel allocation system, the status of the reusable transport packaging may change from available to occupied, in this case where the system event is a delivery event.

In one embodiment of the method, each service point is in communication with an external server and the method may comprise the further act of communicating using one or more mobile smart devices, such that the datasets and/or electronic tokens are piggybacked between the external server and the one or more service points.

In one aspect, the system, wherein the reusable transport packaging may be used, may further comprise a user application adapted to be installed on a distributed network of mobile smart devices. In this use, the electronic tokens may be piggybacked by the user application between the server and the one or more service points.

The mobile smart device installed with the user application may be one out of a distributed network of mobile smart devices installed with the user application.

Each user electronic token may be piggybacked by a single user application installed on a specific mobile smart device of the distributed network of mobile smart devices installed with the user application.

For each user electronic token, one or more synchronisation electronic tokens and/or acknowledgement electronic tokens may be piggybacked by one or more user applications of the distributed network of mobile smart devices, which user application may be another than the one carrying the other types of e-tokens related to the same piece.

One effect of piggybacking of the e-tokens may be that different communication standards may be used between the user application and the service point and between the user application and the server, respectively.

One communication standard could be WPAN. Using WPAN may extend the distribution and reach of the system, as the service points may be located without being dependent on data transmission supporting mobile communication systems and stable power supply.

The use of e-tokens being piggybacked in the parcel allocation system may furthermore be used to support communication of the reusable transport packaging in regard to ensuring an updated status of the single pieces of reusable transport packaging. A consequence of piggybacking may be that a synchronisation e-token to be communicated from the service point to the external server via the user application may not reach the server at all or may reach the external server long after the event has been performed. By sending an acknowledgement e-token, a verification of the received synchronisation e-token may be achieved. Hence, a handshake for the received synchronisation e-token is performed.

Another effect of piggybacking may be that the mobile smart devices do not access the content of the e-tokens. This may be advantageous both in regard to the robustness of the parcel allocation system and the mobile smart device. A robust system may refer to a system with a high security against hacking. A robust system may also refer to a system with a high level of redundancy.

In one embodiment of the method, the status of the reusable transport packaging may comprise a state and a location.

In one embodiment of the method, the status of the reusable transport packaging may comprise a state and a location.

The state may include available, occupied, under repair, temporary removed from the parcel allocation system, reserved/booked, rejected or other useable states for the current use and/or subsequent use of the packaging.

The location may include the location coupled to a state. The location may include the current location and the current state e.g. the packaging is currently occupied at service point X. Another example of a status could include an upcoming booking of the packaging and hence, the status may include a period e.g. the reusable transport packaging with transport packaging ID Y: available until year.mm.dd. hour at location X.

The location may be given as an ID of a service point, a distribution centre, a storage location, a retailer, other users etc. This may be given as an ID of some kind. Alternatively, the location may be given by a GPS location.

The status of the reusable transport packaging may comprise further information or the transport packaging ID may be associated with other information of the reusable transport packaging and the use hereof.

The working principle may be that the chip may comprise a transport packaging ID, which links the reusable transport packaging to information of the status and/or additional information associated with the reusable transport packaging. The additional information may be included in the status.

The additional information associated with the reusable transport packaging may include size and/or dimensions of the reusable transport packaging. This may include internal dimensions and/or external dimension.

The additional information associated with the reusable transport packaging may indude which material the packaging is made of, the conditions that it can withstand, which types of products it may be useable for, the number of times is has been used, age, physical condition or other information which may be useful for determining the next use of the reusable transport packaging.

The status may be determined based on system events performed in the parcel allocation system. For example, the status can be set to occupied, at the time the empty reusable transport packaging is collected from a collect point e.g. a service point, if the packaging is booked by a retailer and collected for example by a courier to be delivered thereto. Furthermore, the status may be set to ‘retailer Z’, ‘courier Z’, a GPS point or another suitable location. The occupied status may include that no specific location is recorded in the status, in view of privacy considerations. The status may change to available state, once the parcel have been delivered to a service point and the piece have been removed. The location may be the ID or GPS location of the service point.

In one aspect, the method may comprise a further act of using a distribution centre for distributing reusable transport packaging.

In one aspect, the method may comprise a further act of using a storage centre for storing reusable transport packaging.

In one aspect, the method may include an act of allocating reusable transport packaging to a single user.

This may include that the reusable transport packaging temporarily leave the parcel allocation system to re-enter into the parcel allocation system at a later time. The reusable transport packaging may, in this case where it leaves the system, not be associated with a piece and thus may not be coupled to the parcel allocation system in any way until it re-enters the parcel allocation system. However, the reusable transport packaging may still be coupled to a parallel system keeping record of the reusable transport packaging. In this system, the reusable transport packaging, which has left the parcel allocation system, may hold a status of occupied, as the reusable transport packaging is not available to other users.

An object of the disclosure may be achieved by use of a reusable transport packaging with a transport packaging in a parcel allocation system. The parcel allocation system may comprise a server and one or more service points. The parcel allocation system may be in communication with a status server being updated with a status associated with the transport packaging ID. The status may be a function of a system event performed in the parcel allocation system. The use may be for reusing transport packaging.

A parcel may refer to the piece to be delivered and the reusable transport packaging holding the piece.

In one aspect, the chip may be a passive chip.

One effect of the embodiment may be that the reusable transport packaging may be recirculated in the parcel allocation system, thereby making the reusable transport packaging available to any user of the parcel allocation system, and hence take advantage of the distributed architecture of a parcel allocation system to reuse the reusable transport packaging.

Transport packaging may typically be designed for harsh transport conditions to protect the pieces held within from damages. Transport packaging may therefore typically be designed to be sustainable. The transport packaging may therefore be a benefit during transport, however, once a consignee receives the parcel, the transport packaging may be an inconvenience. For the consignee, any further transport of the piece from the service point may not require the same degree of protection and thus the transport packaging may not be required. Therefore, the sustainable transport packaging may become an inconvenience for the consignee both in regard to handling a parcel with added weight and size compared to only handling the actual piece and subsequently to dispose of the transport packaging.

One advantage of the use for reusing transport packaging may be that the consignee may just collect the piece and leave the transport packaging at the service point. The transport packaging may be reused by a subsequent user of the system e.g. a consignor who orders a new delivery of a piece to be collected at the present service point (collect point) and to be delivered at a different service point using a reusable transport packaging. The consignor may simply arrive at the present collect point and arrange the piece to be shipped in the reusable transport packaging.

Thus, an additional advantage may be that the consignor himself does not have to purchase suitable transport packaging but simply make use of existing reusable transport packaging.

Availability of reusable transport packaging and the distribution hereof within the system can benefit from the parcel allocation system competence herein to recircle the reusable transport packaging to a service point, a retailer location or comparable locations where the demand by the next user arises.

Today, much transport packaging is of a material and a quality which may make it suitable for being reused. By making small changes or minor refits, including at least having a chip fixed thereto, existing transport packaging may be used according to the above disclosed embodiment.

In one aspect, the system, wherein the reusable transport packaging may be used, may further comprise a user application adapted to be installed on a distributed network of mobile smart devices. In this use, the datasets to be communicated may be piggybacked by the user application between the server and the one or more service points.

In a further aspect, the reuse of the reusable transport packaging may be performed according the disclosed method using the same means.

One effect of using the reusable transport packaging in a parcel allocation system where the e-tokens are piggybacked is that the reusable transport packaging can be used with systems communicating via WPAN communication standards. This may extend the distribution and reach of the system, as the service points may be located without being dependent on data transmission supporting mobile communication systems and stable power supply.

An object of the disclosure may be achieved by a packaging reusing system for reusing reusable transport packaging. The packaging reusing system may comprise a status server and reusable transport packaging adapted for holding a piece. The packaging reusing system may comprise means adapted for receiving a dataset of a system event from a parcel allocation system and for transmitting a status of the reusable transport packaging to a parcel allocation system. The reusable transport packaging may comprise a transport packaging ID. The transport packaging ID may be associated with a status of the reusable transport packaging. The status of the reusable transport packaging may be dependent on the received dataset of the system event from the parcel allocation system.

Equivalent to the embodiments of the method of reusing the reusable transport packaging and the use of a reusable transport packaging in a parcel allocation system, the packaging reusing system may ensure a distributed architecture for allocation of the reusable transport packaging in a given parcel allocation system. The status server of the packaging reusing system may be directly coupled to the parcel allocation system or be an external status server.

On effect of the packaging reusing system may, similar to the use of a reusable transport packaging in a parcel allocation system, be that the reusable transport packaging may be recirculated in the associated parcel allocation system thereby making the reusable transport packaging available to any user of the parcel allocation system, and hence take advantage of the distributed architecture of a parcel allocation system to distribute the reusable transport packaging.

The packaging reusing system may provide the same effects and advantages as the previously described embodiments of the method of reusing the reusable transport packaging and the use of a reusable transport packaging in a parcel allocation system and hence, the same exemplified scenarios with comparable effects and advantages may be achieved by the method of reusing a reusable transport packaging in a parcel allocation system.

A significant point for both the use of a reusable transport packaging in a parcel allocation system and the method of reusing a reusable transport packaging is that existing parcel allocation systems may be used and thus the use and the method may be implemented therein.

In one aspect, the packaging reusing system may comprise a distribution centre for distributing reusable transport packaging.

In one aspect, the packaging reusing system may comprise a storage centre for storing reusable transport packaging.

In one embodiment of the packaging reusing system, the parcel allocation system may comprise one or more service points and an external server. The packaging reusing system may further comprise means adapted for performing the acts of the method of reusing the reusable transport packaging.

A significant point also for this embodiment of the packaging reusing system similar to the embodiments of use of a reusable transport packaging in a parcel allocation system and the method of reusing a reusable transport packaging in a parcel allocation system is that existing parcel allocation systems may be used.

As previously described, the packaging ID may be linked to a status and additional information. This may be comprised in a record on a server of the parcel allocation system or at an external server. Thus, the administrating of tracking and distributing the actual reusable transport packaging may be performed by a computer program product being separate from a computer program product of the parcel allocation system performing the tracking and distribution of parcels within that system. As a consequence hereof, the reusable transport packaging may be used in multiple parcel allocation systems. Furthermore, the multiple parcel allocation systems may be operated completely separated from and independently of each other.

One simplified example of a record for administrating tracking and distributing of the actual reusable transport packaging may include status, condition, age and use linked to the packaging ID:

| Packaging | | | | Age | Use |
|---|---|---|---|---|---|
| ID | Status, State | Status, Location | Condition | (days) | (no) |
| 34 | Occupied | Service point 56 | OK | 244 | 102 |
| 645 | Occupied | In transit | OK | 24 | 4 |
| X | Available | Courier Z | OK | 54 | 7 |
| X | Available | Service point Z | To be re- | 122 | 51 |
| | | | paired | | |
| X | Occupied | Retailer Z | To be re- | 34 | 4 |
| | | | paired | | |
| X | Temporary re- | Retailer Z | OK | 244 | 99 |
| | moved | | | | |
| X | Damaged | Courier Z | To be re- | 543 | 207 |
| | | | cycled | | |

In general, the status of the reusable transport packaging may be associated with system events in the parcel allocation system. This association may be through information of acts or information relating to acts to be performed, being performed or which have been performed. This could be through the use of sequence numbers, generation of particular types of electronic tokens, transmittance and/or receiving of particular information etc.

The system events could include
placing the parcel (piece+reusable transport packaging) at a location X,
leaving the reusable transport packaging at service point X,
opening a parcel locker door,
closing a parcel locker door,
entering a pin, scanning a code, using an electronic key, validation,
etc, depending on how the parcel allocation system is operated.

In one embodiment of the packaging reusing system, the system may further comprise a user application adapted to be installed on a distributed network of mobile smart devices. In this embodiment, the electronic tokens may be piggybacked by the user application between the server and the one or more service points.

Equivalent to the embodiments of the use of a reusable transport packaging in a parcel allocation system and the method of reusing a reusable transport packaging in a parcel allocation system which is further comprising a user application adapted to be installed on a distributed network of mobile smart devices, this embodiment of the packaging reusing system implemented in a similar parcel allocation system may have the similar effects including:
That the packaging reusing system can be implemented in a parcel allocation system which can use different communication standards including WPAN communication standards. This may extend the distribution and reach of the system, as the service points may be located without being dependent on data transmission supporting mobile communication systems and stable power supply.
That the communicated data in the parcel allocation system and thus the data used in the packaging reusing system may not be accessed by the mobile smart devices. This may be advantageous both in regard to the robustness of the packaging reusing system and the mobile smart device. A robust system may refer to a system with a high security against hacking. A robust system may also refer to a system with a high level of redundancy.

In one aspect, the packaging reusing system may provide for allocating reusable transport packaging to a single user.

This may include that the reusable transport packaging temporarily leaves the parcel allocation system to re-enter into the parcel allocation system at a later time. The reusable transport packaging may, in this case where it leaves the system, not be associated with a piece and thus may not be coupled to the parcel allocation system in any way until it re-enters the parcel allocation system. However, the reusable transport packaging may still be coupled to the packaging reusing system keeping record of the reusable transport packaging. In this system, the reusable transport packaging, which has left the parcel allocation system, may hold a status of occupied, as the reusable transport packaging is not available to other users.

An object of the disclosure may be achieved by a transport packaging adapted for holding a piece. The transport packaging may comprise a chip with a packaging ID. The chip may be fixed to the transport packaging. The transport packaging may be a reusable transport packaging and the packaging ID may be adapted to be associated with a status of the reusable transport packaging. The status may be a function of the system event in a parcel allocation system.

Equivalent to the embodiments of the use of a reusable transport packaging in a parcel allocation system, the method of reusing a reusable transport packaging in a parcel allocation system and the packaging reusing system, this embodiment of a transport packaging being a reusable transport packaging may ensure that the reusable transport packaging may be implemented in a distributed architecture for allocation of the reusable transport packaging in a given parcel allocation system.

On effect of the reusable transport packaging may, similar to the use of a reusable transport packaging in a parcel allocation system, be that the reusable transport packaging may be recirculated in an associated parcel allocation system, thereby making the reusable transport packaging available to any user of the parcel allocation system, and hence take advantage of the distributed architecture of a parcel allocation system to distribute the reusable transport packaging.

This embodiment of the reusable transport packaging may contribute to the embodiments of the use, the method and the packaging reusing system to achieve for the effects and advantages as those previously described and hence, the same exemplified scenarios with comparable effects and advantages may be achieved through this reusable transport packaging.

Similar to the use of a reusable transport packaging in a parcel allocation system, the method of reusing a reusable transport packaging in a parcel allocation system and the packaging reusing system, a significant point for the reusable transport packaging is that it may also be implemented and used with existing parcel allocation systems.

In one embodiment of the reusable transport packaging, the chip may be a passive chip, preferably a RFID chip.

Using a passive chip may reduce the cost of the reusable transport packaging. Furthermore, a high security level of the system may be achieved, as not data may be lost, if the transport packaging is lost. Furthermore, leak of information from the chip may not cause any privacy violation.

One advantage of using RFID chips may be that a collection of chips may be read in a single action such that a courier may gain a status of the content transport packaging and/or parcels in a single reading. Furthermore, the RFID ship may have a long battery life due to the low energy consumption.

In one embodiment, the reusable transport packaging may comprise fixation means for supporting the piece inside the reusable transport packaging and comprise sealing means which are resealable.

The reusable transport packaging may be made with different dimensions, shapes and/or materials. Thus, the reusable transport packaging may be categorised with a type, which identifies which types of pieces the transport packaging is useful for and may fit inside.

However, the transport packaging may not suit perfectly to each individual piece. The fixation means may therefore ensure that the piece can be fixed inside the transport packaging. This may be beneficial for using one type of transport packaging for a broad range of piece dimensions and/or shapes. Furthermore, extra packaging material may be significantly reduced or avoided and thus reduce the use of one-use packaging material. The sealing means may be means included on the outside of the transport packaging, which may ensure that the transport packaging is securely closed during transport. The sealing means may further include validation or security seals, which may indicate if the transport packaging has been opened during shipment.

An object of the disclosure may be achieved by a user application configured to communicate electronic tokens between a server and a service point. The user application may be adapted to be installed on a mobile smart device comprising a processor and communication means.

This embodiment may have the effects and advantages in line with those previously described in connection with the use of a mobile smart device for carrying and transmitting—or piggybacking—the communicated data, including:
The service point may only need to communicate with a mobile smart device within a short distance, thereby enabling the use of a low-power-consuming data communication connection.
The communication between the service point and the user application may not require any internet connection at the service point location, thereby avoiding adding any extra power load to the mobile smart device with the installed user application when picking up the parcel. A more power-consuming communication with the server may be performed at a later time.
The user application only sends the e-token to an associated service point and only piggybacks small amounts of encrypted data from the service point to the server.
The recipient may use the user application installed on a mobile smart device for picking up the parcel and thus, the recipient of the parcel already has the user application activated when picking up the parcel, and the piggybacking of one or more e-tokens back to the server may not include any further actions from the recipient. Furthermore, the e-tokens may be passive and/or encrypted data, and therefore do not add any further risk to the users of a mobile smart device.
The use of piggybacking may result in that a synchronisation e-token to be communicated from the service point to the server via the user application may not reach the server at all or may reach the server long after the event has been performed. But this may be accounted for by transmitting several e-tokens comprising overlapping information, or by transmitting the same e-token to multiple user applications.

In one aspect, the user application may be configured to perform a further act of displaying information adapted to be displayed on a screen connected to or part of a mobile smart device comprising a processor and transmitter/receiver means.

A further effect of this embodiment may be that any displaying of information may be performed by an external screen included in or connected to the mobile smart device, such that the method may display information but without requiring a service point with a display unit for performing the method. This may be advantageous in regard to omitting any costs for installing and maintaining such a display unit but also in regard to achieving a method wherein the method acts performed by the service point(s) may be kept at a minimum of power consumption.

Furthermore, this embodiment may have the effect that the service point may enable units typically used today for picking up parcels, such as a display and an input unit, which may be a key pad, a scanner or a touch screen, to display information and/or guide the user of the delivery or pick-up event, which often includes entering a code for the delivery or pick-up event.

An object of the disclosure may be achieved by computer program products comprising instructions to cause a parcel allocation system to execute the method acts of any of the methods for reusing a reusable transport packaging.

One effect of this embodiment may be that the reusable transport packaging may be implemented and used in existing parcel allocation systems, with the effects and advantages previously described in that connection.

An object of the disclosure may be achieved by computer program products comprising instructions to cause the status server to execute the method acts of any of the methods for reusing a reusable transport packaging.

These acts may include receiving a system event from a parcel allocation system, transmitting a status of the reusable transport packaging to a parcel allocation system and update status of the reusable transport packaging.

One effect of this embodiment may be that the status server and/or the packaging reusing system may be implemented into or coupled to existing parcel allocation systems, with the effects and advantages previously described in that connection.

Furthermore, the packaging reusing system may be implemented into or coupled to multiple existing parcel allocation systems.

An object of the disclosure may be achieved by computer-readable media having stored thereon one or more of the computer program products.

One effect of this embodiment may be to support the method of using the reusable transport packaging, the use of the reusable transport packaging and the packaging reusing system to be implemented in and/or used with existing parcel allocation systems.

### DESCRIPTION OF THE DRAWINGS

FIG. 1 illustrates one embodiment of the packaging reusing system and one embodiment of reusing the reusable transport packaging in a parcel allocation system.

FIG. 2 illustrates one embodiment of the packaging reusing system implemented in a parcel allocation system.

FIG. 3 illustrates one embodiment of the packaging reusing system implemented in a parcel allocation system.

FIG. 4 illustrates one embodiment of the packaging reusing system implemented in a parcel allocation system using a distributed network of user applications for communication within the parcel allocation system.

FIG. 5 illustrates one embodiment of a parcel locker.

FIG. 6 illustrates one embodiment of the method of reusing a reusable transport packaging.

FIG. 7 illustrates one embodiment of the method of reusing a reusable transport packaging in a parcel allocation system.

FIG. 8 illustrates two embodiments of a reusable transport packaging.

FIG. 9 illustrates another two embodiments of a reusable transport packaging.

### DETAILED DESCRIPTION OF THE DISCLOSURE

10 Electronic tokens
20 Service point
30 External server
40 Piece
50 User electronic token
54 System event
58 Sequence number
59 Dataset
60 Synchronisation electronic token
70 Acknowledgement electronic token
80 Service point signal
90 User application
92 Mobile smart device
94 Processor (mobile smart device)
96 Communication means (mobile smart device)
100 Method
102 Transmitting (service point)
104 Receiving (service point)
108 Generating (service point)
122 Transmitting (server)
124 Receiving (server)
128 Generating (server)
134 Determining
150 Communicating
170 Reusing
182 Using
184 Associating
200 Parcel locker
202 Service point communication means
206 Service point processor
210 Parcel locker chassis
212 Compartments
214 Lockable door
215 Mechanical lock
302 Server communication means
306 Server processor means
400 Parcel allocation system
500 Use
600 Reusable transport packaging
602 Transport packaging ID
610 Chip
620 Status
622 State
624 Location
630 Sealing means
632 Security seal
640 Supporting means
700 Packaging reusing system
730 Status server

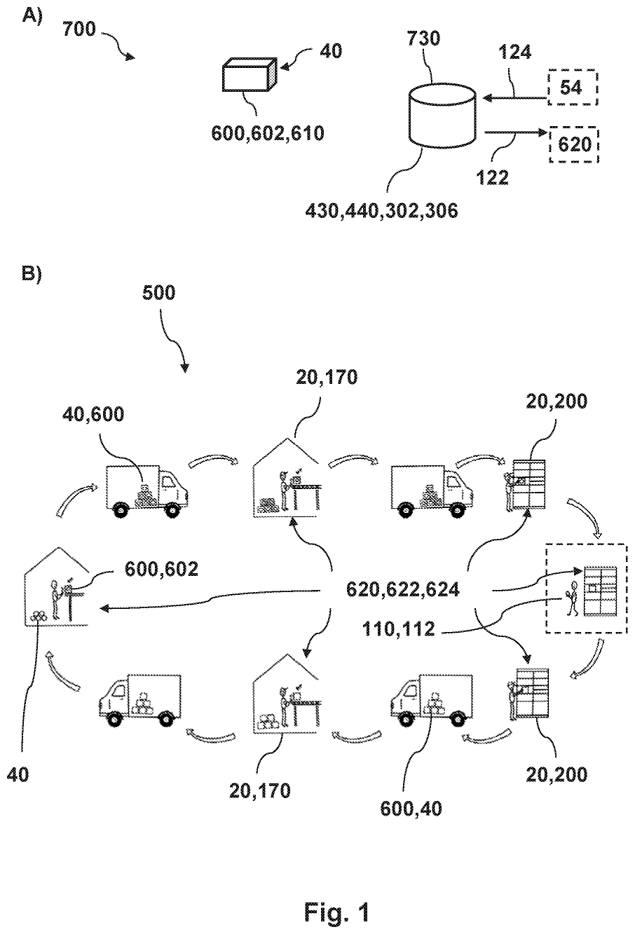

FIG. 1A illustrates one embodiment of the packaging reusing system 700. The system comprises a status server 730 and reusable transport packaging 600.

The reusable transport packaging 600 may be adapted for holding a piece 40. The reusable transport packaging 600 comprises a chip 610 with a transport packaging ID 602. The chip 610 may be fixed to the reusable transport packaging 600. This could include the chip being integrated into the material of the reusable transport packaging 600, the chip being clued to, rivet to, welded to, or otherwise inextricably linked with the reusable transport packaging 600.

The chip may be a passive chip. In one aspect the chip may be a RFID.

The packaging reusing system 700 may further comprises server communication means 302 adapted for receiving data of a system event 54 from a parcel allocation system and for transmitting a status 620 of the reusable transport packaging 600 to a parcel allocation system. These means 302 may be comprised in the status server 730.

The transport packaging ID 602 may be associated with a status 620 of the reusable transport packaging 600, which status is dependent on the received data of a system event 54 from the parcel allocation system. The status server 730 may store and update a record with the current status 620 of each reusable transport packaging 600 via use of the transport packaging IDs 602. The status server 730 may comprise computer readable media 440 to store a computer program product 430 and comprise server processor means 306 for executing the computer program product 430 to perform the acts described above. The status server 730 may be incorporated or comprised in a server in the parcel allocation system.

FIG. 1B illustrates one embodiment of using 500 the reusable transport packaging 600 in a parcel allocation system and one embodiment of the 100 of reusing a reusable transport packaging 600.

The parcel allocation system may comprise one or more service points 20. The service points may comprise one or more parcel lockers 200. Alternatively, the service points 20 may be manned service centres, shops, postal offices or comparable arrangements.

The use 500 of the reusable transport packaging 600 in the parcel allocation system is for reusing 170 transport packaging.

In the illustrated embodiment, a retailer wishes to send pieces to his costumers, which they have ordered. The retailer is provided with reusable transport packaging 600 each with a unique transport packaging ID 602. The retailer packs the ordered pieces 40 in suitable reusable transport packaging 600 resulting in a number of parcels (a parcel being a reusable transport packaging 600+one or more ordered pieces 40). The retailer orders a courier service to deliver the parcels. The courier service picks up the parcels and delivers the parcels to a distribution centre. The distribution centre may act as a service point 20 depending on how the parcel allocation system is organised.

The courier service may bring other parcels from other retailers. The courier service may also bring empty reusable transport packaging 600 for distribution within the parcel allocation system, thereby recirculation empty reusable transport packaging 600 for reuse 170. The distribution centre may redirect both parcels and empty reusable transport packaging 600 to other users of the parcel allocation system e.g. consignors to receive empty reusable transport packaging 600 for later use or consignees to receiving parcels.

From the distribution centre a courier service may receive parcels and/or empty reusable transport packaging 600 to be delivered at different service points 20, which may act as collect or delivery place for parcels but also for empty reusable transport packaging 600. At the service point 20, the courier service delivers the parcels booked for this given service point 20.

The service point 20, may now act not only as a delivery and collect place. Due to the reusable transport packaging 600, the consignee now opens the parcel, picks up the ordered piece and leaves the empty reusable transport packaging at the service point. Thus the service point 20 now also may act as a distribution centre for the reusable transport packaging 600.

The service point may also be used for the opposite case, namely that a consignor orders a delivery of a parcel from a service point 20, which delivery the consignor orders as a delivery using a reusable transport packaging 600. In this case, the courier service may deliver an empty reusable transport packaging 600 to the service point 20, the consignor then, at the service point, places the piece to be sent in the reusable transport packaging 600 and now the parcel can be collected by a courier service for distribution of the parcel.

Hence, a courier service may both deliver and collect parcels and/or empty reusable transport packaging 600 to/from a service point 20. The courier service may service a route with several service points 20 and/or distribution centres.

In the illustrated embodiment, the courier service subsequent to a delivery/collection at a service point 20 continues to a distribution centre. Similar to previously mentioned, the distribution centre may act as a service point 20 depending on how the parcel allocation system is organised. The courier service may now deliver or collect parcels and/or empty reusable transport packaging 600. From the distribution centre, empty reusable transport packaging 600 may be delivered by a courier service to the retailer (or other retailers), who wishes to send new pieces to his costumers, which they have ordered. Thereby, recirculation of the empty reusable transport packaging 600 and hence reuse 170 is achieved.

To reuse the reusable transport packaging 600, the empty reusable transport packaging 600 should preferably be constantly recirculated within the system by being distributed to consignors.

In the illustrated embodiment, the reusable transport packaging comprises a transport packaging ID 602 and a status 620 is associated herewith. The status 620 may comprise information of the state 622, which could include occupied or available. Additional states such as damaged, rejected, reserved could be included.

The status 620 may also comprise information of location 624 of the reusable transport packaging. The location 624 may be given as an ID of a service point, a distribution centre, a storage location, a retailer or other users. Alternatively, the location may be given by a GPS location. The location may only be part of the status when the reusable transport packaging 600 is in connection with the service points 20.

The status 602 may be determined based on system events performed in the parcel allocation system. For example, the status 620 can be set to occupied already when the empty reusable transport packaging 600 is collected from a service point 20 if it is booked by a retailer. This status may be set due to the system event of a courier collecting the reusable transport packaging at the service point. The occupied status may include that no location is recorded in the status. Once the status 620 changes to available state 622 due to the parcel having been delivered to a service point 20 and the piece 40 has been removed, the status 620 may include the location 624, being for example the ID or GPS location of the service point.

One embodiment of the method 100 of reusing a reusable transport packaging 600 is illustrated by the part captured by the dashed lines. The method performed at the service point 20 comprises the acts of changing 110 the content of the reusable transport packaging 600 and updating 112 a status 620 associated with the transport packaging ID 602.

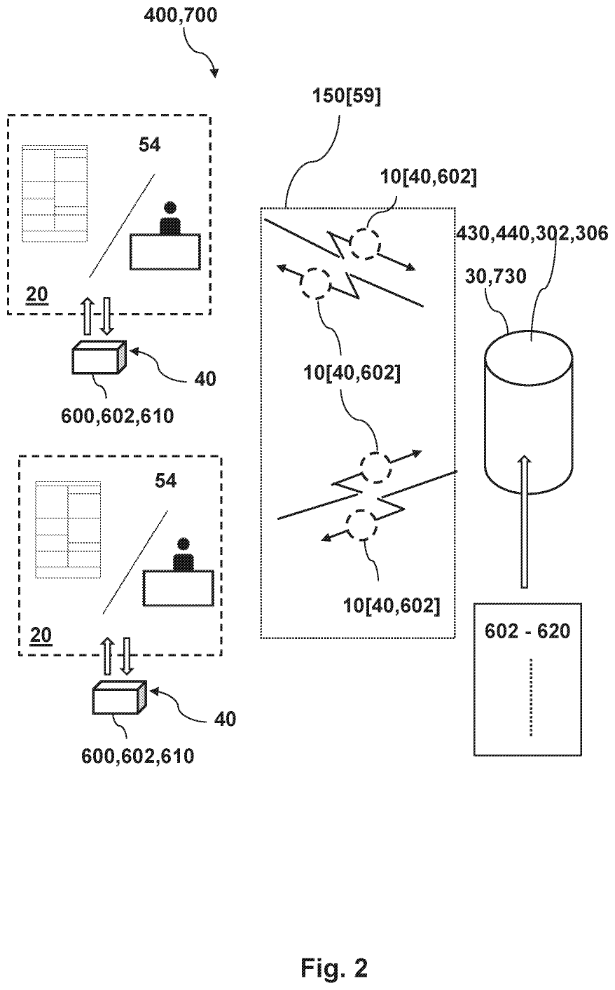

FIG. 2 illustrates one embodiment of the packaging reusing system 700 implemented in a parcel allocation system 400. The packaging reusing system 700 comprises reusable transport packaging 600 comprising a chip 610 and a transport packaging ID 602.

The reusable transport packaging 600 can hold a piece 40 to be sent from a consignee to a consignor. The piece 40 can be associated with a piece ID.

The reusable transport packaging 600 holding a piece 40 may be referred to as a parcel.

The packaging reusing system 700 may comprise a status server 730 having server communication means 302, computer readable media 440, a computer program product 430 and server processor means 306 for executing the computer program product 430.

The transport packaging ID 602 may be associated with a status 620 of the reusable transport packaging 600, which status is dependent on received data of a system event 54 from the parcel allocation system. The status server 730 may store and update a record with the current status 620 of each reusable transport packaging 600 via use of the transport packaging IDs 602.

In the illustrated embodiment, the parcel allocation system 400 comprises one or more service points 20 and a server 30. The status server 730 and the server 30 may be incorporated or comprised in a single server unit.

The parcel allocation system 400 is operated by communicating datasets 59 between the server 30 and a service point 20.

The parcel allocation system 400 is here more explicitly illustrated to be operated by transmitting electronic tokens 10 between the server 30 and a service point 20. The electronic tokens 10 may be associated with a piece 40. For each piece 40 a sequence of electronic tokens comprising a user electronic token 50, a synchronisation electronic token 60 and an acknowledgement electronic token 70 may be generated. The electronic tokens 50,60,70 in the sequence may be generated dependent on performed system events 54 in the parcel allocation system 400.

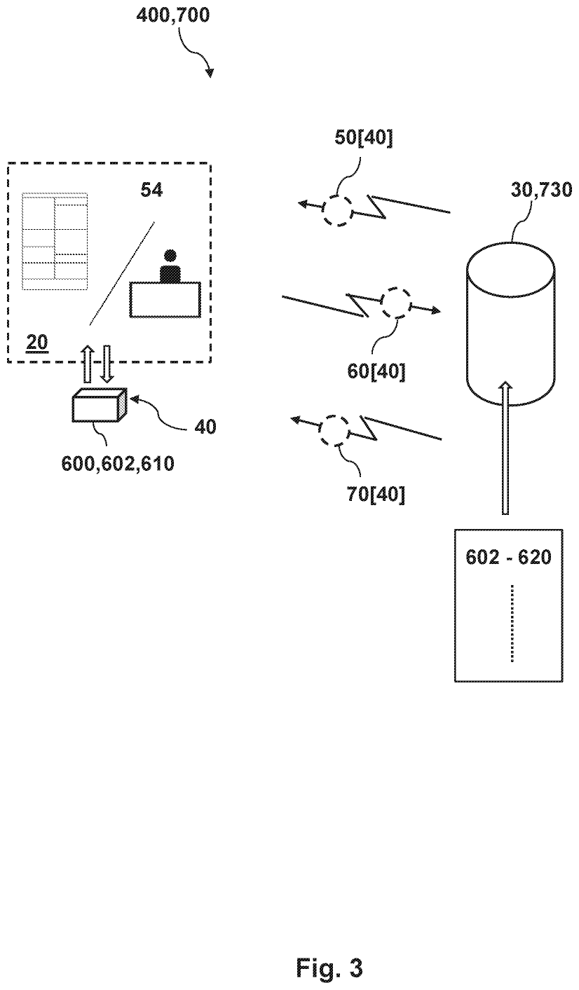

FIG. 3 illustrates one exemplified embodiment of the packaging reusing system 700 implemented in the parcel allocation system 400 of FIG. 2. Here, only a single service point 20 and the communication between the server 30 and the service point 20 for a single piece 40 is illustrated. The communication is achieved with the sequence of electronic tokens comprising a user electronic token 50, a synchronisation electronic token 60 and an acknowledgement electronic token 70, which may be generated in response to or dependent on data of service events generated or received in the parcel allocation system.

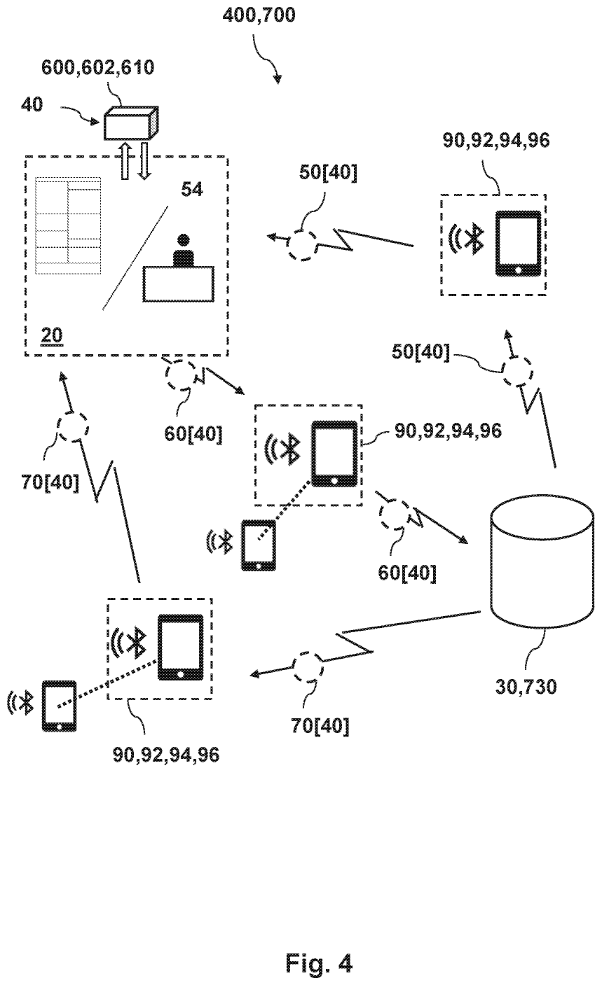

FIG. 4 illustrates one exemplified embodiment of the packaging reusing system 700 implemented in the parcel allocation system 400 of FIGS. 2 and 3. Similar to FIG. 3, only a single service point 20 and the communication between the server 30 and the service point 20 for a single piece 40 is illustrated. In the illustrated embodiment, the packaging reusing system 700 is implemented in a parcel allocation system 400 using a distributed network of user applications 90 for communication within the parcel allocation system 400. The user applications may be installed on a distributed network of mobile smart devices. In this parcel allocation system 400, the electronic tokens 50,60,70 may be piggybacked by the user application between the server and the service point 20.

The user electronic token may be piggybacked by a single user application installed on a specific mobile smart device. For each user electronic token, one or more synchronisation electronic tokens and/or acknowledgement electronic tokens may be piggybacked by one or more user applications of the distributed network of mobile smart devices. Hence, the one or more user applications of the distributed network of mobile smart devices piggybacking the synchronisation e-token and the acknowledgement token may be different from each other and different from the user application carrying the user e-token. The multiple synchronisation electronic tokens and/or acknowledgement electronic tokens for each user electronic token may be identical copies. Hence, the multiple synchronisation electronic tokens may be identical and the acknowledgement electronic tokens may be identical.

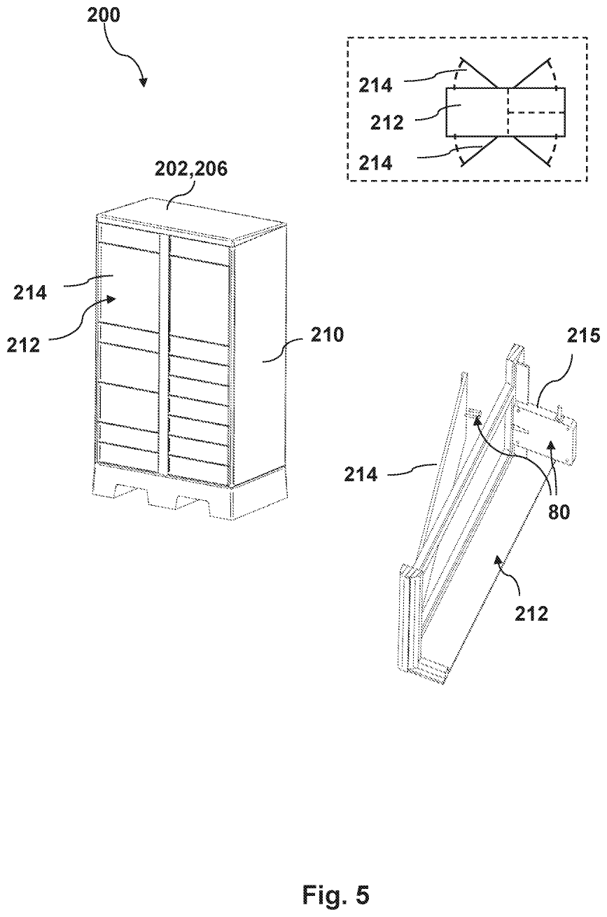

FIG. 5 illustrates one embodiment of a parcel locker 200. The illustrated parcel locker 200 comprises a parcel locker chassis 210, one or more compartments 212, each compartment having at least one mechanical lockable door 214 configured to be locked to the parcel locker chassis 210. The parcel locker may further comprise a battery such that the parcel locker may be battery-operated. The parcel locker 200 may further comprise service point transmitter means 202, service point receiver means and service point processor means 206.

In one insert, a close-up of a mechanical lockable door 214 with a mechanical lock 215 of the parcel locker 200 is illustrated. The one or more mechanical locks 215 and/or mechanical lockable doors 214 receives a service point signal 80 to perform a service point event.

In another insert, an embodiment of the parcel locker 200 is illustrated from a top view. The parcel locker comprises multiple compartments 212, each compartment having at least one mechanical lockable door 214 configured to be locked to the parcel locker chassis. In the illustrated embodiment, the parcel locker 200 is designed with reach-through compartments 212 on the left-hand side of the parcel locker. In this embodiment, the reach-through compartments have two doors, a front-end door and a back-end door accessing a single compartment 212. This can facilitate front-end and back-end loading of the compartment. The reach-through compartment may in other embodiments only comprise a single door 214 and thus being front-end loaded. The parcel locker 200 is also illustrated with half-through compartments 212 on the right hand side of the parcel locker. In this embodiment, the half-through compartments have a single door accessing a single compartment 212 facilitating front-end loading of the compartment.

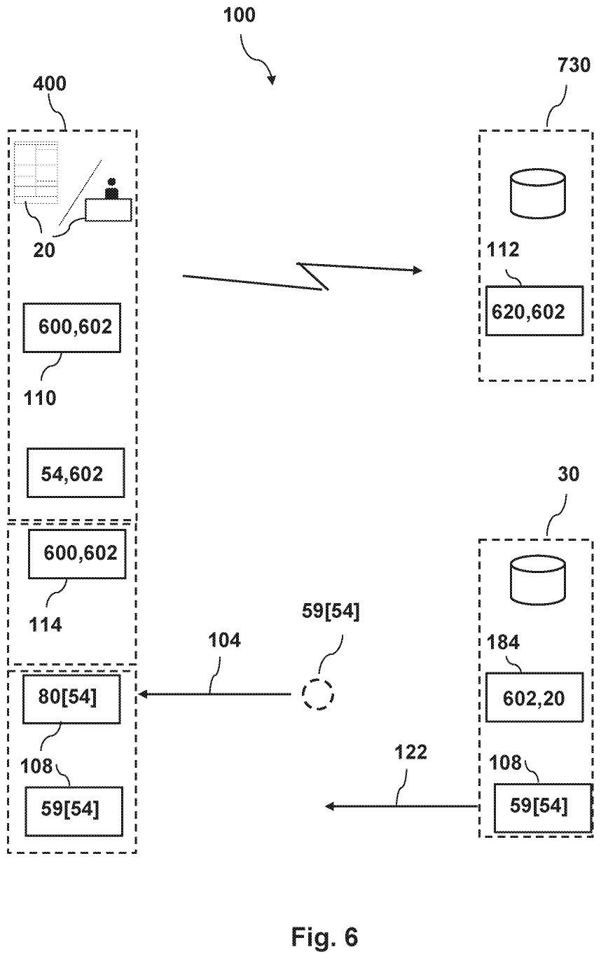

FIG. 6 illustrates multiple embodiments of the method 100 for reusing a reusable transport packaging 600, using a status server 730 in communication with in a parcel allocation system 400. The parcel allocation system 400 comprises one or more service points 20.

In one embodiment, the method 100 comprises acts performed at the service point 20 of changing 110 the content of the reusable transport packaging 600 and updating 112 in the status server 730 a status 620 associated with the transport packaging ID 602. The status 620 is a function of a system event 54 performed in the parcel allocation system (400).

In one further embodiment, the method 100 comprises the further act of leaving 114 the reusable transport packaging 600 at the service point 20 of the parcel allocation system 400.

In one further embodiment, the method 100 comprises the further acts of the service point of receiving 104 a dataset 59 of a system event 54 to be performed, generating 108 a service point signal 80 for the system event 54 and generating 108 a dataset 59 for a performed system event 54 associated with the transport packaging ID 602.

In yet one further embodiment, wherein the parcel allocation system 400 comprises an external server 30 in communication with the one or more service points 20, the method 100 comprises the acts performed at the external server 30 of associating 184 the transport packaging ID 602 directly or indirectly with a service point 20, and generating 128 and transmitting 122 a dataset 59 of a system event 54 to be performed at the service point 20.

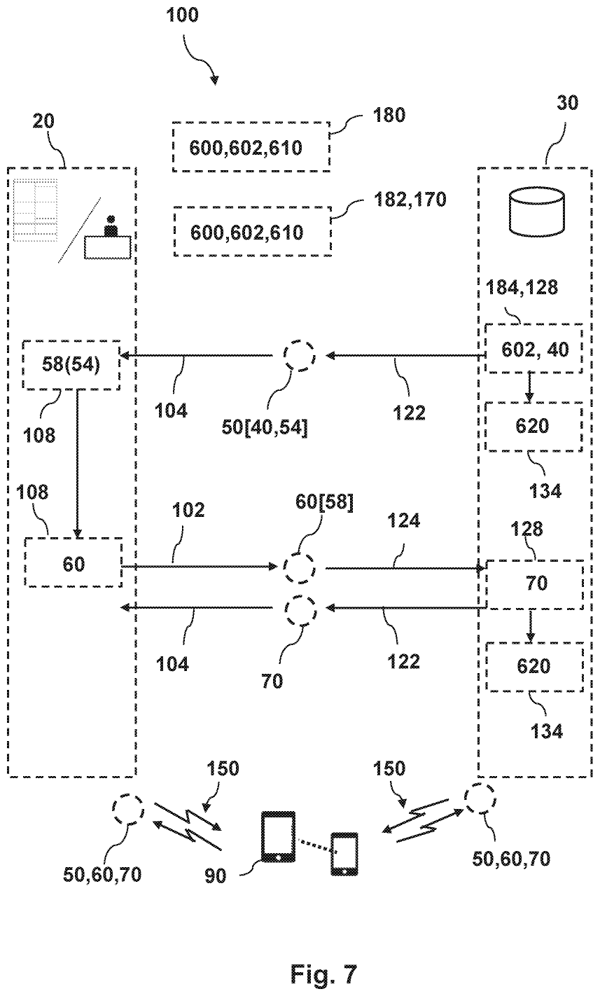

FIG. 7 illustrates one embodiment of the method 100 for reusing a reusable transport packaging 600 in a parcel allocation system comprising a server 30 and one or more service points 20. In the parcel allocation system, electronic tokens are transmitted between the server 30 and a service point 20. The electronic tokens may be associated with a piece 40. For each piece 40 a sequence of electronic tokens comprising a user electronic token 50, a synchronisation electronic token 60 and an acknowledgement electronic token 70 may be generated. The electronic tokens 50,60,70 in the sequence may be generated dependent on performed system events 54 in the parcel allocation system.

The method 100 comprises one or more acts of providing a reusable transport packaging 600. The reusable transport packaging 600 comprises a chip 610 with a transport packaging ID 602. The chip 610 may be fixed to the reusable transport packaging 600. The method 100 further comprises one or more acts of using 182 the provided reusable transport packaging 600.

In the server 30, the transport packaging ID 602 is associated 184 with a piece 40, and a user electronic token 50 associated with the piece 40 is generated 128 and transmitted 122. The user electronic token 50 may comprise data of a system event 54 to be performed in the parcel locker system.

The user electronic token 50 is received 104 in a service point 20 and a sequence number 58 for the system event 54 associated with the piece 40 is generated 108. The sequence number 58 may be generated in connection with the system event 54 being performed, as a subsequent step or when it is most suitable in regard to the information flow in the method.

The method further comprises an act of generating 108 a synchronisation electronic token 60 in the service point. The synchronisation electronic token 60 comprises the generated sequence number 58 and the synchronisation electronic token 60 is transmitted from the service point 20.

The synchronisation electronic token 60 is received 124 in the server 30 and in response to the received synchronisation electronic token 60 an acknowledgement electronic token 70 is generated 128 and transmitted 122. The acknowledgement electronic token 70 is received 104 in the service point 20.

A further act is performed in the server 30 of determining 134 a status 620 of the reusable transport packaging 600. The status 620 is dependent on generated or received data of a system event 54 comprised in an electronic token 50,60,70 associated with the transport packaging ID 602.

In a further embodiment of the method, the parcel allocation system further comprises a user application 90 adapted to be installed on a distributed network of mobile smart devices, such that the electronic tokens 50,60,70 are piggybacked by the user application 90 between the server 30 and the one or more service points 20.

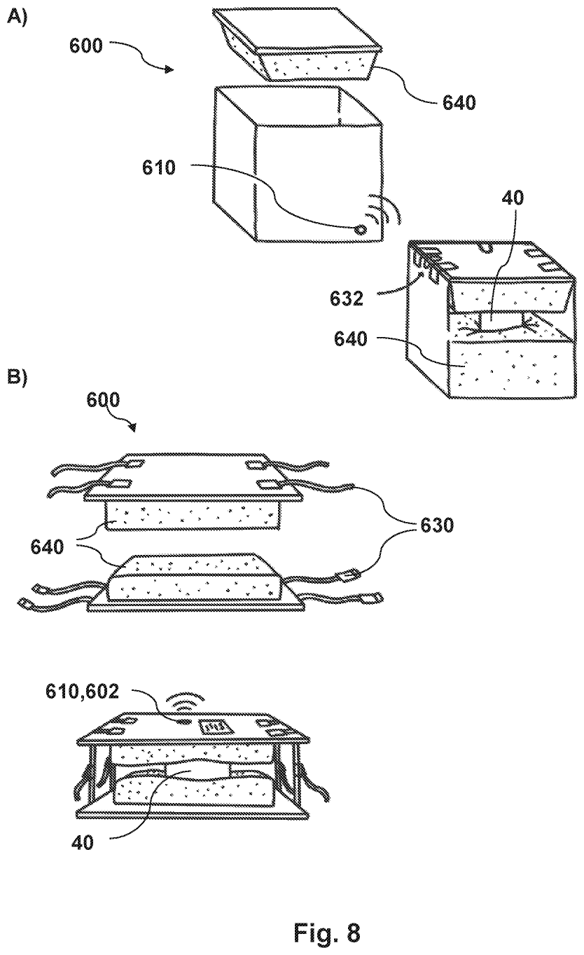

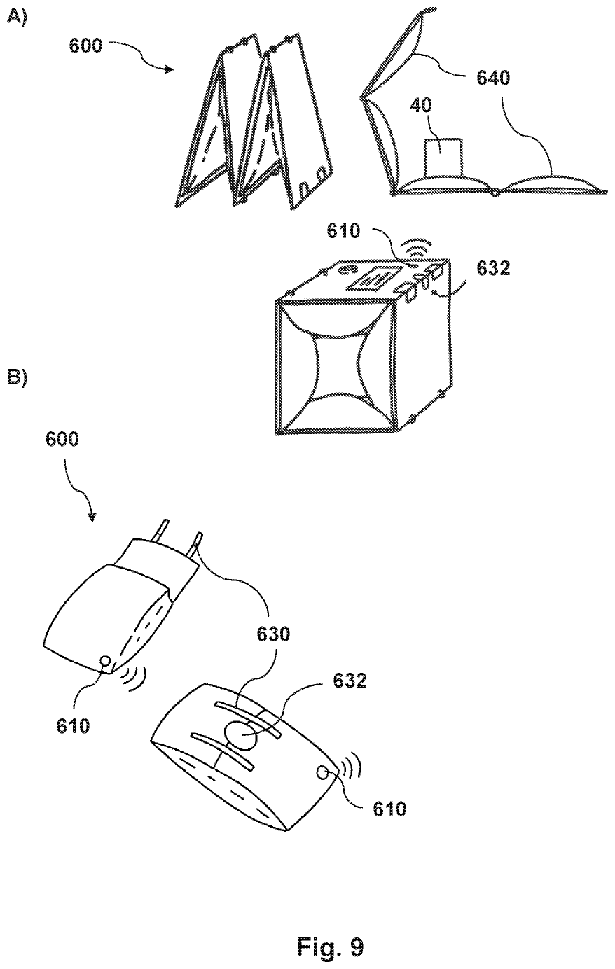

FIGS. 8 and 9 illustrate four embodiments of a reusable transport packaging 600. The reusable transport packaging 600 is adapted for holding a piece 40 and comprises a chip 610 with a transport packaging ID 602. The chip may be fixed to the reusable transport packaging 600. This could include the chip being integrated into the material of the reusable transport packaging 600, the chip being clued to, rivet to, welded to, or otherwise inextricably linked with the reusable transport packaging 600.

The chip may be a passive chip. In one aspect the chip may be a RFID.

The illustrated reusable transport packaging 600 in FIGS. 8B and 9B comprises resealable sealing means 630.

The reusable transport packaging 600 in FIGS. 8A, 8B and 9A are illustrated with fixation means 640 for supporting a piece 40 to be placed inside the reusable transport packaging 600. These fixation means are in FIGS. 8A and 8B illustrated by the dotted areas.

The reusable transport packaging 600 in FIGS. 8A, 9A and 9B are illustrated with security means 632. These may be used for validating that the reusable transport packaging 600 is unopened during transport from the consignor to consignee.

1. Method of reusing reusable transport packaging with a transport packaging ID, using a status server in communication within a parcel allocation system including one or more service points, the method including the following acts at the service point:
providing the reusable transport packaging at the service point;
changing the content of the reusable transport packaging;
updating in the status server a status associated with the transport packaging ID, where the status is a function of a system event performed in the parcel allocation system; and
reusing the provided reusable transport packaging at the service point.

2. The method according to claim 1, further including the act of leaving the reusable transport packaging at the service point of the parcel allocation system.

3. The method (100) according to claim 1, wherein acts of the service point further include:
receiving a dataset of a system event to be performed;
generating a service point signal for the system event, and
generating a dataset for a performed system event associated with the transport packaging ID.

4. The method according to claim 1, wherein the parcel allocation system includes an external server in communication with the one or more service points, said method further includes the following acts performed at the external server:
associating the transport packaging ID directly or indirectly with a service point, and
generating and transmitting a dataset of a system event to be performed at the service point.

5. The method according to claim 4, further including the following acts for each reusable transport packaging:
generating a sequence of successive electronic tokens associated directly or indirectly with the transport packaging ID and a service point;
transmitting the electronic tokens between the external server and the service point,
wherein the step of generating the sequence of successive electronic tokens includes:
generating a user electronic token including a dataset of the system event to be performed at the external server and transmitting the user electronic token to the service point;
generating a synchronisation electronic token at the service point in response to the performed system event and transmitting the synchronization electronic token to the external server, and
generating an acknowledgement electronic token at the external server in response to the received synchronisation electronic token and transmitting the acknowledgement electronic token to the service point.

6. The method according to claim 5, wherein each service point is in communication with an external server and the method further includes the acts of: communicating using one or more mobile smart devices, such that the datasets and/or electronic tokens are piggybacked between the external server and the one or more service points.

7. The method according to claim 1, wherein the status of the reusable transport packaging includes a state and a location.

8. A service point comprising:
means configured and arranged for
providing reusable transport packaging,
changing the content of the reusable transport packaging,
updating in a status server a status associated with a transport packaging ID associated with the reusable transport packaging, where the status is a function of a system event performed in a parcel allocation system, and
reusing the provided reusable transport packaging;
service point storage means configured and arranged for storing a transport packaging; and
service point communication means configured and arranged for receiving and transmitting data of system events.

9. The service point according to claim 8, further including
a service point processor configured and arranged to generate a service point signal to perform a service point event, and
a parcel locker with a parcel locker chassis, and one or more compartments, each compartment having at least one mechanical lockable door with a mechanical lock configured and arranged to be locked to the parcel locker chassis,
wherein the service point processor is a central processor configured and arranged to communicate with external units and to generate service point signals to the one or more mechanical locks and/or mechanical lockable doors depending on the system event.

10. A packaging reusing system for reusing reusable transport packaging comprising:
a status server; and
reusable transport packaging configured and arranged to hold a piece;
means configured and arranged to
receive a dataset of a system event from a parcel allocation system and for
transmit a status of the reusable transport packaging to a parcel allocation system, said reusable transport packaging including a transport packaging ID associated with a status of the reusable transport packaging, where the status is dependent on the received dataset of the system event from the parcel allocation system; and
the parcel allocation system includes one or more service points, an external server and further means configured and arranged for
providing reusable transport packaging,
changing the content of the reusable transport packaging,
updating in a status server a status associated with a transport packaging ID associated with the reusable transport packaging, where the status is a function of a system event performed in a parcel allocation system, and
reusing the provided reusable transport packaging.
